(19) United States
(12) Patent Application Publication
(10) Pub. No.: US 2013/0111353 A1
(43) Pub. Date: May 2, 2013

(54) MEDICAL COORDINATION SYSTEM

(71) Applicant: Yutaka Ueda, Hachioji-shi (JP)

(72) Inventor: Yutaka Ueda, Hachioji-shi (JP)

(73) Assignee: Konica Minolta Medical & Graphic, Inc., Tokyo (JP)

(21) Appl. No.: 13/578,875

(22) PCT Filed: Feb. 14, 2011
(86) PCT No.: PCT/JP2011/053002

§ 371 Date: Aug. 14, 2012

(30) Foreign Application Priority Data
Feb. 16, 2010 (JP) 2010-031277

(51) Int. Cl. H04L 29/08; G06F 3/0481; G06F 19/00

(52) U.S. Cl. CPC H04L 67/32; G06F 3/04817
USPC 715/748; 709/219

(57) ABSTRACT

A medical coordination system includes a data management server and an in-facility system. The in-facility system each include a terminal device and an in-facility server which is connected to the terminal device and which stores medical information data generated in the medical facility, and the data management server includes a storage unit which stores medical information data transmitted from the terminal device of the in-facility system. When the medical information data is transmitted to an in-facility server of an affiliate that is permitted to view the medical information data, the transmission is performed either directly to the in-facility server of the affiliate or via the terminal device of the affiliate, in accordance with a demand from the terminal device of the affiliate.

### TECHNICAL FIELD

The present invention relates to a medical coordination system.

### BACKGROUND ART

Today, with the development of medical technique, a system of coordination of regional medicine is becoming widespread, and a plurality of medical facilities such as hospitals and clinics with certain functions are coordinated for treatment of a patient.

In order to share medical information data such as medical image data, sample examination data, electronic chart data, interpretation report, etc. among the affiliated medical facilities, for example, as shown in Patent Document 1, medical information data is transferred by using media such as CD-R (Compact Disc Recordable), DVD (Digital Versatile Disc), etc.

There is also a known system, for example, to share medical information data managed in each medical facility among an entire group (entire area) of medical facilities to which the medical facility belongs. According to the system, an in-facility server of each medical facility is connected to a center server through a communication network and the medical information data is uploaded from the in-facility server to the center server. Medical information data among the facilities can be provided and obtained by access from each in-facility server to the center server.

### PRIOR ART DOCUMENT

### Patent Document

Patent Document 1: Japanese Patent Application Laid-Open Publication No. 2008-134986

### DISCLOSURE OF THE INVENTION

### Problems to be Solved by the Invention

However, a medical facility with a policy that does not allow the in-facility server to connect directly with an external network cannot use a system where it is necessary for the in-facility server to be connected with an external center server. Therefore, such medical facilities exchange medical information data with other medical facilities through media offline. However, data transfer through media include problems such as possibility of media being lost, not being able to transfer data promptly, etc. Also, when a medical facility which allows the in-facility server to connect with the external network coordinates data with a medical facility which does not allow connection with the external network, data needs to be transferred through media, and it is not possible to smoothly coordinate data.

Therefore, there is a need for a configuration of coordinating data online which can be adapted to communication conditions of various medical facilities.

The problem to be solved by the present invention is to provide a medical coordination system capable of online data coordination that can deal with communication conditions of various medical facilities.

### Means for Solving the Problem

In order to achieve the above object, according to a first aspect of the present invention, a medical coordination system includes:

a data management server; and

an in-facility system provided in each of a plurality of medical facilities, the in-facility system connected to the data management server through a communication network to enable transmission and reception of data,

wherein the in-facility system each include a terminal device and an in-facility server which is connected to the terminal device and which stores medical information data generated in the medical facility, and

the data management server includes a storage unit which stores medical information data transmitted from the terminal device of the in-facility system associated with identification information of the transmission source of the medical information data and identification information of an affiliate that is permitted to view the medical information data, and when transmitting the medical information data to an in-facility server of the affiliate that is permitted to view the medical information data, the transmission is performed either directly to the in-facility server of the affiliate or via the terminal device of the affiliate, in accordance with a demand from the terminal device of the affiliate.

Preferably, the data management server creates a medical information display screen which displays medical information data permitted to be viewed in accordance with a demand from the terminal device of the affiliate that is permitted to view the medical information data, the medical information display screen including a first functional button to transmit to the data management server a demand to transmit the medical information data to the in-facility server of the affiliate and a second functional button to select a transmission method of the medical information data to the in-facility server from between “direct transmission” or “via terminal device”, and the data management server transmits the medical information display screen to the terminal device of the affiliate; and

the terminal device of the affiliate displays the medical information display screen transmitted from the data management server on a display unit, and when the first functional button is pressed, the terminal device demands to the data management server to transmit the displayed medical information data to the in-facility server of the affiliate with the transmission method selected using the second functional button.

Preferably, the medical information display screen includes a third functional button to download medical information data displayed in the medical information display screen to the terminal device of the affiliate; and

when the third functional button of the medical information display screen is pressed, the terminal device of the affiliate demands transmission of the medical information data to the data management server and downloads the medical information data.

Preferably, the medical information display screen includes an input field to input a comment on the medical information data displayed in the medical information display screen, and a fourth functional button to transmit the input comment to the data management server;

when the comment is input from the input field of the medical information display screen and the fourth functional button is pressed, the terminal device of the affiliate transmits the input comment to the data management server; and

the data management server stores in the storage unit the comment transmitted from the terminal device of the affiliate associated with identification information of the transmission source of the medical information data and the identification information of the affiliate, and transmits the comment from the affiliate to the terminal device of the transmission source in accordance with a demand from the terminal device of the transmission source of the medical information data.

Preferably, the treatment information display screen includes a fifth functional button to import new medical information data from the in-facility server connected to the terminal device of the affiliate and a sixth functional button to transmit the imported medical information data to the data management server;

when the fifth functional button is pressed, the terminal device of the affiliate imports new medical information data from the in-facility server and when the sixth functional button is pressed, the imported new medical information data is transmitted to the data management server; and

the data management server stores in the storage unit the new medical information data transmitted from the terminal device of the affiliate associated with identification information of the transmission source of the original medical information data and the identification information of the affiliate, and creates the medical information display screen to display the new medical information data and transmits the medical information display screen to the terminal device of the transmission source in accordance with a demand from the terminal device of the transmission source of the original medical information data.

Preferably, the medical information display screen includes a seventh functional button to create an interpretation report of the medical information data displayed in the medical information display screen;

when the seventh functional button is pressed, the terminal device of the affiliate displays an input screen to input the interpretation report and transmits the interpretation report input from the input screen to the data management server; and

the data management server stores in the storage unit the interpretation report transmitted from the terminal device of the affiliate associated with identification information of the transmission source of the medical information data and the identification information of the affiliate, and creates the medical information display screen to display the interpretation report from the affiliate together with the medical information data and transmits the medical information display screen to the terminal device of the medical facility of the transmission source in accordance with a demand from the terminal device of the transmission source of the medical information data.

Preferably, the medical information display screen includes an eight functional button to edit the displayed medical information data and a ninth functional button to transmit the edited medical information data to the data management server;

when the eight functional button is pressed, the terminal device of the affiliate performs editing processing on the displayed medical information data and when the ninth functional button is pressed, the terminal device of the affiliate transmits the edited medical information data to the data management server; and

the data management server stores in the storage unit the edited medical information data transmitted from the terminal device of the affiliate as a file different from the medical information data before editing associated with identification information of the transmission source of the medical information data before editing and the identification information of the affiliate, and creates the medical information display screen to display the edited medical information data and transmits the medical information display screen to the terminal device of the transmission source in accordance with a demand from the terminal device of the transmission source of the medical information data before editing.

Preferably, the edited medical information data and the medical information data before editing are displayed aligned in the medical information display screen to display the edited medical information data and a mark is added to the edited medical information data to show that the medical information data is edited.

Preferably, the medical information display screen to display the edited medical information data includes a tenth functional button to store the medical information data before editing and after editing as separate data or to overwrite the medical information data before editing with the edited medical information data in the in-facility server connected to the terminal device of the transmission source of the medical information data before editing.

Preferably, each of the terminal devices includes a print device;

the medical information display screen includes an eleventh functional button to print the medical information data displayed in the medical information display screen onto a sheet; and

when the eleventh functional button is pressed, the terminal device of the affiliate allows the print device to print based on the medical information data.

Preferably, the medical information data includes DICOM data, general use image data and a document file.

Preferably, the data management server creates a medical information importing screen including a twelfth functional button to import the medical information data from the in-facility server and transmits the medical information importing screen to the terminal device in accordance with a demand from the terminal device;

the terminal device displays the medical information importing screen transmitted from the data management server on the display unit and when the twelfth functional button is pressed, the terminal device imports the medical information data from the in-facility server;

the data management server creates a request input screen including an input field to input an affiliate that is permitted to view the medical information data imported from the in-facility server and a content of request to the affiliate and a thirteenth functional button to transmit to the data management server the medical information data imported from the in-facility server and transmits the request input screen to the terminal device in accordance with a demand from the terminal device;

the terminal device displays the request input screen transmitted from the data management server on the display unit, and when the affiliate and the request content are input from the input field and the thirteenth functional button is pressed, the imported medical information data and the affiliate and the request content input from the input field are transmitted to the data management server; and

the data management server stores in the storage unit the transmitted medical information data and the request content associated with identification information of the transmission source and the identification information of the affiliate that is permitted to view the medical information data, and generates the medical information display screen to display the medical information data permitted to be viewed together with the request content and transmits the medical information display screen to the terminal device of the affiliate, in accordance with a demand from the terminal device of the medical facility of the affiliate permitted to view the medical information data.

Preferably, the in-facility server includes:
a storage unit which stores medical information data generated in a medical facility;
a display unit which displays the medical information data stored in the storage unit;
an operation unit which receives input of information of an affiliate that is permitted to view the medical information data displayed on the display unit; and
a transmission unit which transmits information of the affiliate input with the operation unit and the medical information data displayed on the display unit to the data management server.

### Advantageous Effect of the Invention

According to the present invention, it is possible to provide a medical coordination system capable of online data coordination that can deal with communication conditions of various medical facilities.

### BRIEF DESCRIPTION OF THE DRAWINGS

FIG. 1 is a diagram showing an entire configuration of a regional medical coordination system according to an embodiment of the present invention;

FIG. 2 is a block diagram showing a functional configuration of a center server shown in FIG. 1;

FIG. 3 is a block diagram showing a functional configuration of a terminal device shown in FIG. 1;

FIG. 4 is a diagram showing an example of a coordination transmitted and received history screen displayed on a display unit shown in FIG. 3;

FIG. 5 is a diagram showing an example of a viewer screen displayed on the display unit shown in FIG. 3;

FIG. 6 is a diagram showing an example of a download destination selection screen displayed on the viewer screen shown in FIG. 5;

FIG. 7 is a diagram showing an example of a registration screen displayed on the viewer screen shown in FIG. 5;

FIG. 8 is a diagram showing an example of a transmitting destination PACS selection screen displayed on the viewer screen shown in FIG. 5;

FIG. 9 is a diagram showing an example displaying new medical information data and edited medical information data on the viewer screen shown in FIG. 5;

FIG. 10 is a diagram showing an example of a display setting screen displayed on the coordination transmitted and received history screen shown in FIG. 4;

FIG. 11 is a diagram showing an example of a PACS import setting screen displayed on the viewer screen shown in FIG. 5;

FIG. 12A is a diagram showing an example of a report creating screen displayed on the display unit shown in FIG. 3;

FIG. 12B is a diagram showing an example of an interpretation report;

FIG. 13A is a diagram showing an example of a medical information import screen displayed on the display unit shown in FIG. 3;

FIG. 13B is a diagram showing an example of a medical information selection screen displayed on the display unit shown in FIG. 3;

FIG. 13C is a diagram showing an example displaying medical information data imported from the PACS to a medical information display field shown in FIG. 13A; and

FIG. 14 is a diagram showing an example of an affiliate selection screen displayed on the display unit shown in FIG. 3.

### EMBODIMENT FOR CARRYING OUT THE INVENTION

An embodiment of the present invention is described in detail with reference to the diagrams. However, the scope of the invention is not limited to the illustrated examples.

### [Configuration of Regional Medical Coordination System 100]

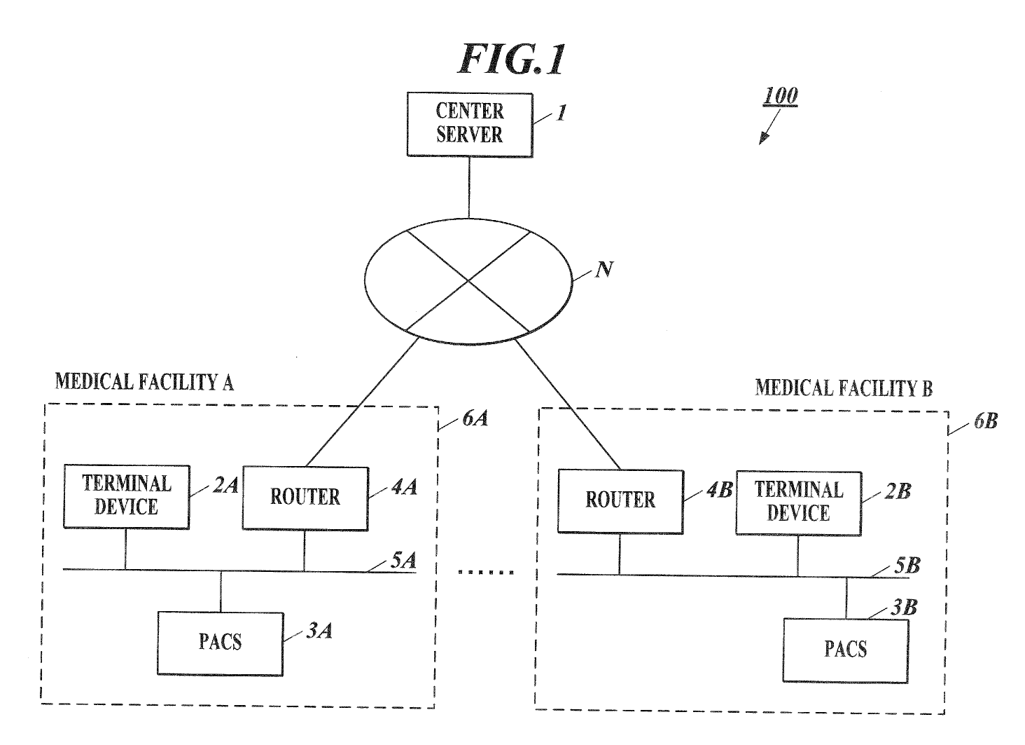

FIG. 1 shows a system configuration of a regional medical coordination system 100 of the present embodiment.

As shown in FIG. 1, the regional medical coordination system 100 includes a center server 1 provided in a regional data center, an in-facility system 6A provided in a medical facility A, and an in-facility system 6B provided in a medical facility B.

The in-facility system 6A is configured including a terminal device 2A and a PACS (Picture Archiving and Communication System) 3A connected to each other through an in-facility network 5A such as a LAN (Local Area Network) to be able to transmit and receive data. Each device comprising the in-facility system 6A is connected to the internet N through a router 4A. Among the devices which compose the in-facility system 6A, at least the terminal device 2A is communicated to be able to transmit and receive data to and from the center server 1 with the router 4A through the internet N.

Similarly, the in-facility system 6B is configured including a terminal device 2B and a PACS (Picture Archiving and Communication System) 3B connected to each other through an in-facility network 5B such as a LAN to be able to transmit and receive data. Each device comprising the in-facility system 6B is connected to the internet N through a router 4B. Among the devices which compose the in-facility system 6B, at least the terminal device 2B is communicated to be able to transmit and receive data to and from the center server 1 with the router 4B through the internet N.

The in-facility system composing the regional medical coordination system 100 and the number of devices of the in-facility system is not limited to the above.

Each device composing the regional medical coordination system 100 is described below.

### [Center Server 1]

The center server 1 is a data management server which is provided in the data center and which provides medical coordination service (coordination service) among medical facilities.

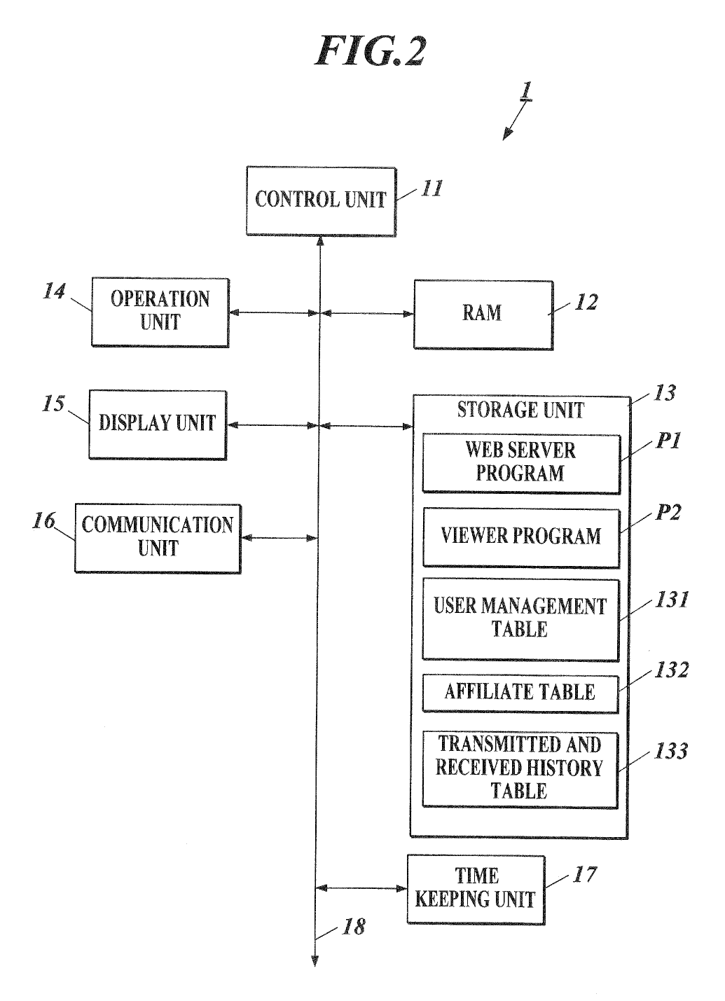

FIG. 2 shows an example of a functional configuration of the center server 1.

As shown in FIG. 2, the center server 1 includes a control unit 11, a RAM 12, a storage unit 13, an operation unit 14, a display unit 15, a communication unit 16, a time keeping unit 17 and the like and each unit is connected to each other by a bus 18.

The control unit 11 is composed of a CPU (Central Processing Unit), etc. The control unit 11 reads out various programs such as a system program stored in the storage unit 13 to be expanded in the RAM 12, and the control unit 11 executes various processing according to the expanded program. For example, the control unit 11 executes processing performed in the center server among the various processing such as a later described transmitted and received history display processing according to Web server program P1 and viewer program P2 stored in the storage unit 13.

The RAM 12 forms a work area to temporarily store various programs read out from the storage unit 13 to be executed by the control unit 11, input and output data, parameters, etc. used in the various processing controlled by the control unit 11.

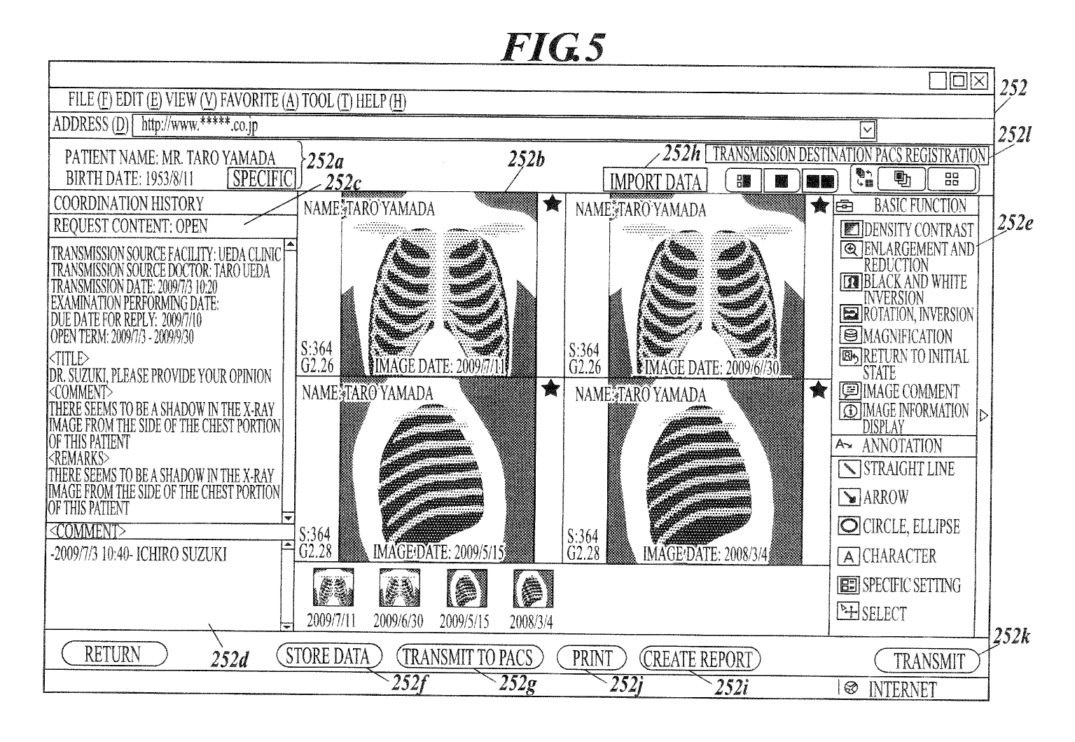

The storage unit 13 is composed of a HDD (Hard Disk Drive), semiconductor nonvolatile memory, etc. The storage unit 13 stores various programs as described above. For example, other than the system program, the storage unit 13 stores a Web server program P1 to execute a function as a Web server to provide various Web screens such as a viewer screen 252 (see FIG. 5) to a Web browser by communication with a Web browser included in the terminal devices 2A and 2B and HTTP protocol, a Web application program (called a viewer program P2) which operates on the Web server and provides coordination service to the user of the terminal devices 2A and 2B through the Web browser and the like.

The storage unit 13 stores a user management table 131, an affiliate table 132, a transmitted and received history table 133, medical information data, etc. transmitted from the terminal device 2A, 2B, etc.

The user management table 131 is a table which stores user information regarding a user (doctor) which can use the coordination system by the center server 1. The user management table 131 is provided with items to identify the user such as “user ID”, “login password”, “facility ID”, “facility name”, “department”, “doctor name”, “address”, “telephone number”, “e-mail address”, “folder path”, etc. and data of user information including information of the above items is stored.

Here, a folder is provided in the storage unit 13 of the center server 1 for each user to store medical information data transmitted from each user through the terminal devices 2A and 2B. The “folder path” included in the user information is information which shows a path to each folder of the user. The medical information data is information regarding a patient obtained through course of treatment and includes, for example, medical image data, sample examination data, electronic chart data, interpretation report, pathological diagnosis report, etc.

The affiliate table 132 is a table which stores data of information of affiliate candidates (affiliate information) registered by the user. An affiliate is a medical facility or doctor (here, the affiliate is described as a doctor) to which medical coordination is requested. The affiliate table 132 is provided with items to identify the user such as “user ID” and items to identify the affiliate such as “affiliate facility ID”, “affiliate facility name”, “affiliate doctor ID”, “affiliate doctor name”, “affiliate address”, “telephone number”, “e-mail address”, etc. and data of affiliate information including information of the above items is stored. In the present embodiment, “affiliate doctor ID” is a user ID of the affiliate doctor.

The transmitted and received history table 133 is a table which stores history information of transmitting and receiving medical information data and the reply between the user and the affiliate.

The transmitted and received history table 133 is provided with items such as “request ID”, “transmission source information” (“transmission source facility ID”, “transmission source facility name”, “transmission source doctor ID”, “transmission source doctor name”), “transmission destination information” (“transmission destination facility ID”, “transmission destination facility name”, “transmission destination doctor ID”, “transmission destination doctor name”), “transmission date and time”, “patient name”, “classification”, “title”, “comment”, “request/reply division”, “file path”, etc.

The “request ID” is identification information issued each time a coordination request is transmitted from a terminal device 2A or 2B used by the user in a later described new coordination request transmitting processing. The string of data transmitted and received between the user of the request source and the affiliate after the coordination request (for example, medical information data transmitted with the coordination request from the user of the request source, medical information data transmitted as a reply to the user of the request source from the affiliate) is managed by applying the same request ID.

The “transmission source information” is information of the transmission source of the medical information data. For example, when medical information data is transmitted from the user of request source of the coordination request to the affiliate, the transmission source information is the information of the user of the request source and when medical information data (edited medical information data, new medical information data, etc.) is transmitted as a reply to the user of the request source from the affiliate, the transmission source information is information of the affiliate.

The “transmission destination information” is information regarding the transmission destination of the medical information data specified by the transmission source. In other words, the transmission destination is the user permitted to view the medical information data transmitted from the transmission source. For example, when medical information data is transmitted to the affiliate from the user of the request source of the coordination request, the transmission destination information is information of the affiliate, and when the medical information data is transmitted as a reply to the user of the request source from the affiliate, the transmission destination information is information of the user of the request source.

The “classification” is information showing classification of request content. In the present embodiment, classification includes conference (open), interpretation request, lung cancer examination, examination request, referral, etc.

The “title” is the title applied by the transmission source of the medical information data. The “comment” is the comment to the transmission destination input by the transmission source of the medical information data. The “request/reply division” is information showing division of whether the information is a coordination request or a reply. The “file path” is information showing storage location of the file of the medical information data.

The operation unit 14 is composed including a keyboard provided with a cursor key, number input key, various function keys, etc. and a pointing device such as a mouse, etc. and the operation unit 14 outputs a signal of a pressed key pressed on the keyboard and a signal of operation of the mouse as an input signal to the control unit 11.

The display unit 15 is composed including a monitor such as a CRT (Cathode Ray Tube), LCD (Liquid Crystal Display), etc. and displays various screens according to an instruction of a display signal input from the control unit 11.

The communication unit 16 includes a LAN (Local Area Network) adapter, router, TA (Terminal Adapter), etc. and performs transmitting and receiving of data to and from external devices such as terminal devices 2A, 2B, etc. connected through the internet N.

The time keeping section 17 is composed of a RTC (Real Time Clock), etc. and keeps present time and present date to be output to the control unit 11.

### [Configuration of Terminal Devices 2A and 2B]

The terminal devices 2A and 2B are computers equipped with Web browsers.

The terminal device 2A is a computer for a doctor of a medical facility A to coordinate medical treatment with a doctor of another medical facility. In other words, the terminal device 2A is a computer for the doctor of the medical facility A to access to a center server 1 through the internet N to transmit medical information data to the center server 1 and to view and download medical information data which is stored in the center server 1 and which the doctor is allowed to view.

The terminal device 2B is a computer for a doctor of a medical facility B to coordinate medical treatment with a doctor of another medical facility. In other words, the terminal device 2B is a computer for the doctor of the medical facility B to access to a center server 1 through the internet N to transmit medical information data to the center server 1 and to view and download medical information data which is stored in the center server 1 and which the user is allowed to view.

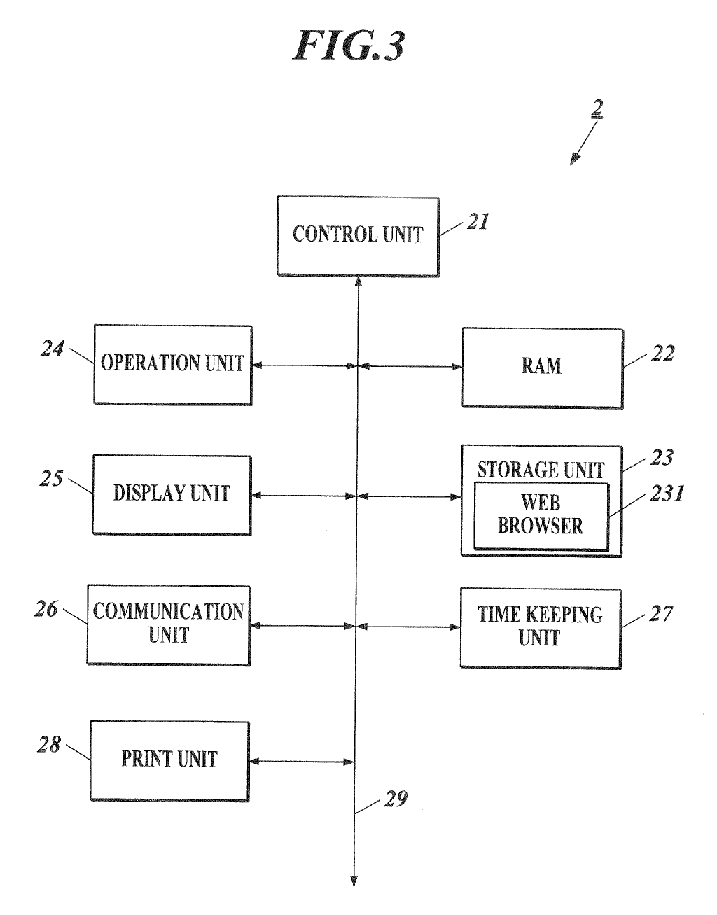

As shown in FIG. 3, the terminal devices 2A and 2B include a control unit 21, a RAM 22, a storage unit 23, an operation unit 24, a display unit 25, a communication unit 26, a time keeping unit 27, a print unit 28, and the like, and each unit is connected to each other by a bus 29, etc.

The functions of the control unit 21, the RAM 22, the storage unit 23, the operation unit 24, the display unit 25, the communication unit 26 and the time keeping unit 27 are substantially similar to the control unit 11, the RAM 12, the storage unit 13, the operation unit 14, the display unit 15, the communication unit 16 and the time keeping unit 17 respectively described in FIG. 2, and only the differences are described below.

The control unit 21 is composed of a CPU, etc. The control unit 21 expands various programs such as a system program stored in the storage unit 23, a Web browser 231 and a script provided by the center server 1, and executes various processing according to the expanded program. For example, the control unit 21 executes processing performed by the terminal device in various processing such as the later described transmitted and received history displaying processing according to the expanded program.

The storage unit 23 is composed of a HDD (Hard Disk Drive), a semiconductor nonvolatile memory, etc. As described above, the storage unit 23 stores various programs and various pieces of data such as a system program executed by the control unit 21 and the Web browser 231.

The print unit 28 prints and outputs an image on a sheet based on print data output by the control unit 21.

### [Configuration of PACS 3A and 3B]

Similar to the center server 1, the PACS 3A and 3B are computers including a control unit, a RAM, a storage unit, an operation unit, a display unit, a communication unit, a time keeping unit, etc. and is an in-facility server which mainly stores medical information data such as medical image data generated by a modality of the medical facility, sample examination data, interpretation report, etc. associated with patient information in the storage unit.

### [Operation of Regional Medical Coordination System 100]

The following is a description of the operation when the doctor of each medical facility uses the terminal device of the facility (terminal devices 2A or 2B) to access to the center server 1 to receive coordination service.

### (Access to Coordination Service)

First, operation of access to the coordination service of the center server 1 from the terminal devices 2A and 2B is described. The operation of the terminal devices 2A and 2B is executed by cooperation between the control unit 21 and the Web browser 231. The operation of the center server 1 is executed by cooperation between the control unit 11 and the Web server program P1. Below, the access operation to the coordination service of the center server 1 from the terminal device 2A is described as a representative example, but the same can be said for the terminal device 2B.

In the terminal device 2A, when a URL to access to the coordination service of the center server 1 is input on the Web browser 231 with the operation unit 24, the input URL is transmitted to the center server 1 with the communication unit 26.

In the center server 1, when a URL to access to the coordination service is received from the terminal device 2A with the communication unit 16, display data for displaying a login screen is transmitted to the terminal device 2A. The display data of various Web screens such as a login screen transmitted to the terminal device 2A by a Web server function of the center server 1 includes HTML, style sheet, image data, a script to execute predetermined processing in the terminal device 2A, etc.

In the terminal device 2A, when display data of the login screen is received with the communication unit 26, the login screen is displayed on the display unit 25. Although not illustrated, the login screen is a screen in which an input field for the user ID and the login password (hereinafter simply referred to as password) is displayed. When the user ID and the password are input from the login screen, the input user ID and password are transmitted to the center server 1 with the communication unit 26.

In the center server 1, when the user ID and the password are received with the communication unit 16, user authentication is executed. Specifically, a record with a user ID which matches with the received user ID is retrieved in the user management table 131 and when the received password matches the retrieved record, it is judged that user authentication is OK. When a record with the user ID which matches with the received user ID is not retrieved or the password of the retrieved record does not match the received password, it is judged that the user authentication is NG. When it is judged that the user authentication is OK, the viewer program P2 stored in the storage unit 13 is started and a coordination service according to operation of the Web browser 231 of the terminal device 2A is provided. When the user authentication is NG, it is notified through the communication unit 16 that the user authentication is NG to the terminal device 2A.

Various processing executed in the center server 1 and the terminal devices 2A and 2B based on the viewer program of the center server 1 are described. The processing in the center server is executed by the control unit 11 of the center server 1 in coordination with the Web server program P1 and the viewer program P2. The processing in the terminal device is executed by the control unit 21 of the terminal devices 2A and 2B in coordination with the Web browser 231 and the script provided by the center server 1. The processing performed by the terminal device is described with the terminal device 2A performing the processing as a representative example, but similar processing is performed in the terminal device 2B.

### (Transmitted and Received History Display Processing)

When the viewer program P2 is started, first, the transmitted and received history display processing which displays on the terminal device 2A the history information of transmitting and receiving medical information data regarding the user who logged in (login user) is executed.

In the transmitted and received history display processing, first, in the center server 1, history information (in other words, history information of medical information data for the login user (medical information data which the login user is allowed to view or which is transmitted from the affiliate as a reply to the coordinate request from the login user) received by the center server 1) including the login authenticated user ID in the transmission destination doctor ID is retrieved from the transmitted and received history table 133. Then, display data of a coordination transmitted and received history screen 251 for displaying the retrieved history information is created and the display data is transmitted to the terminal device 2A with the communication unit 16.

In the terminal device 2A, when the display data of the coordination transmitted and received history screen 251 is received by the communication unit 26, the coordination transmitted and received history screen 251 is displayed on the display unit 25.

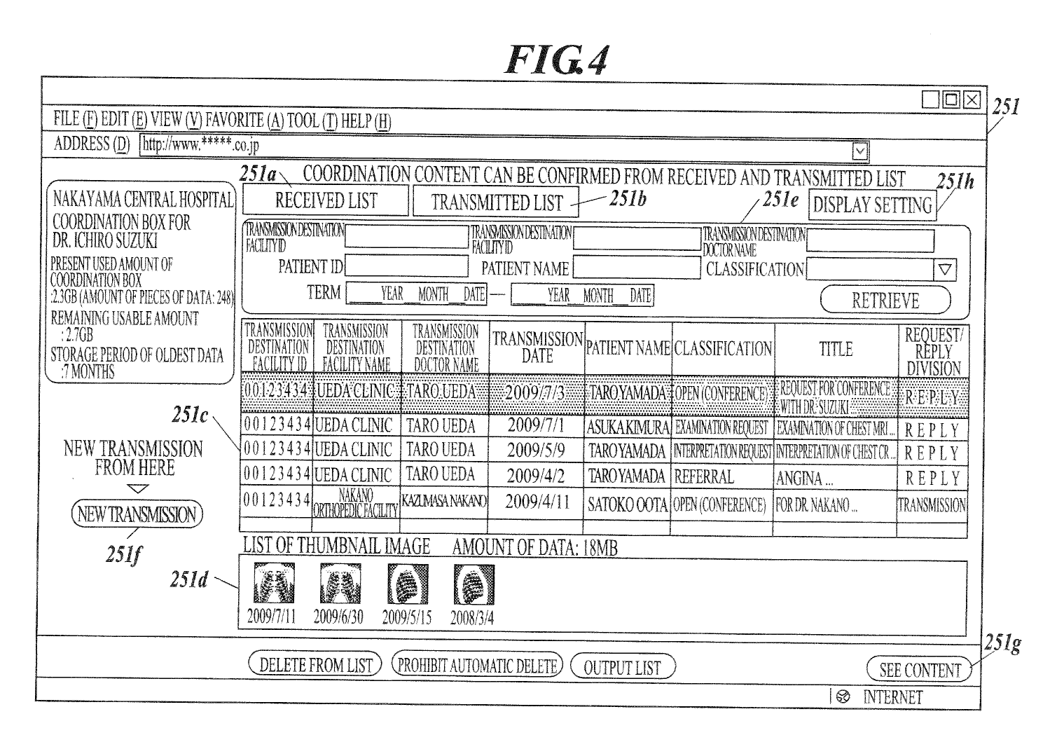

FIG. 4 shows an example of the coordination transmitted and received history screen 251. As shown in FIG. 4, the coordination transmitted and received history screen 251 includes a “received list” button 251a, a “transmitted list” button 251b, a history display field 251c, a thumbnail display field 251d, a retrieval condition input field 251e, a “new transmission” button 251f, a “see content” button 251g, etc.

The “received list” button 251a is a functional button for displaying on the history display field 251c a list (received list) of history information of medical information data which is received by the center server 1 and which is for the login user, in other words, which the login user is allowed to view.

The transmitted list button 251b is a functional button for displaying on the history display field 251c a list (transmitted list) of history information of medical information data which the login user transmitted.

The history display field 251c is a region for displaying the received list or the transmitted list. The history display field 251c displays the received list by default setting. The login user can confirm the received history of medical information data for himself in the center server 1 by viewing the received list of the history display field 251c.

The thumbnail display field 251d is a region for displaying as a thumbnail image the medical information data corresponding to history information selected from the history display field 251c with the operation unit 24.

The retrieval condition input field 251e is a region for input of a condition to narrow the history information displayed in the history display field 251c.

The “new transmission” button 251f is a functional button for transmitting a demand of a new coordination request to the center server 1.

The “see content” button 251g is a functional button for transmitting to the center server 1a display demand of the medical information data corresponding to the history information selected from the history display field 251c.

A “display setting” button 251h is a functional button for setting whether to display the edited medical information data aligned with original medical information data or to display only the edited medical information data when the edited medical information data is displayed on the viewer screen 252 (see FIG. 5). The “display setting” button 251h is a functional button which is displayed when history information of receiving edited medical information data is included.

### (Medical Information Display Processing)

On the coordination transmitted and received history screen 251, when the “see content” button 251g is pressed in a state where history information is selected from the history display field 251c with the operation unit 24, medical information display processing is executed to display the medical information data corresponding to the selected history information so that the login user is able to view the medical information data.

In the medical information display processing, first, a display demand to the viewer screen 252 as a medical information display screen which displays medical information data corresponding to the selected history information is transmitted with the communication unit 26 from the terminal device 2A to the center server 1. Specifically, information specifying the medical information data which is the display target (for example, request ID of the selected history information and transmitted time and date, etc.) and the display demand for the medical information data is transmitted with the communication unit 26 to the center server 1.

In the center server 1, when information specifying the medical information data which is the display target and the display demand of the viewer screen 252 are received, the history information of the medical information data which is the display target is retrieved and read out from the transmitted and received history table 133 and the medical information data is read out from the storage location shown by the “file path” of the retrieved history information. Then, based on the read out history information and the medical information data, the display data of the viewer screen 252 is created and transmitted to the terminal device 2A with the communication unit 16. The history information of the medical information data which is the display target of the viewer screen 252 is stored in the RAM 12 associated with an IP address, etc. of the terminal device 2A until the viewer screen 252 is closed on the terminal device 2A. With this, the medical information data which is the display target of the viewer screen 252 in the terminal device 2A can be easily specified on the center server 1.

In the terminal device 2A, when the display data of the viewer screen 252 is received with the communication unit 26, based on the received display data, the viewer screen 252 displaying the medical information data corresponding to the selected history information is displayed on the display unit 25.

FIG. 5 shows an example of the viewer screen 252. As shown in FIG. 5, the viewer screen 252 is provided with a patient information display field 252a, a medical information display field 252b, a coordination history field 252c, a comment input field 252d, various editing buttons 252e, a data storing button 252f, a PACS transmitting button 252g, a data importing button 252h, a report creating button 252i, a printing button 252j, a transmitting button 252k and the like.

The patient information display field 252a is a region which displays the patient information (name, birth date, etc.) of the patient regarding the medical information data which is the display target of the viewer screen 252.

The medical information display field 252b is a region which displays the medical information data.

The coordination history field 252c is a region which displays a portion of the history information (information of transmission source facility, transmission source doctor, transmitted date and time, title, comment, etc.) regarding the medical information data displayed in the medical information display field 252b.

The comment input field 252d is a region for inputting a comment regarding the displayed medical information data.

The various editing buttons 252e are functional buttons (eight functional button) for performing image processing such as image quality adjustment such as density contrast correction, etc., enlarging and reducing, inversion of black and white, rotation, etc. and editing processing such as adding annotation, etc. to the medical information data (here, medical image data) displayed in the medical information display field 252b.

The data storing button 252f is a functional button (third functional button) for downloading the file of the medical information data displayed in the medical information display field 252b from the center server 1 to the terminal device 2A and storing the file in a predetermined path of the terminal device 2A.

The PACS transmitting button 252g is a functional button (first functional button) for transmitting to the center server 1a demand to transmit to the PACS 3A in the facility the medical information data displayed in the medical information display field 252b.

The data importing button 252h is a functional button (fifth functional button) for importing new medical information data from the PACS 3A in the facility.

The report creating button 252i is a functional button (seventh functional button) for creating an interpretation report of the medical information data displayed in the medical information display field 252b.

The printing button 252j is a functional button (eleventh functional button) for printing medical information data displayed in the medical information display field 252b on a sheet.

The transmitting button 252k is a functional button (fourth functional button, sixth functional button, ninth functional button) for transmitting the comment input from the comment input field 252d, the new medical information data imported from the PACS 3A in the facility, the created interpretation report, etc. to the center server 1 as a reply to the transmission source of the displayed medical information data. It is possible to provide a functional button for each function of transmitting the comment, transmitting the new medical information and transmitting the interpretation report.

The transmission destination PACS registering button 252l is a functional button (second functional button) for registering the address of the PACS 3A in the facility which is the transmission destination of the medical information data displayed in the medical information display field 252b and selecting the method of transmitting the data to the PACS 3A.

### (Medical Information Data Download Processing)

In the viewer screen 252, when the data storing button 252f is pressed with the operation unit 24, the medical information data download processing is executed.

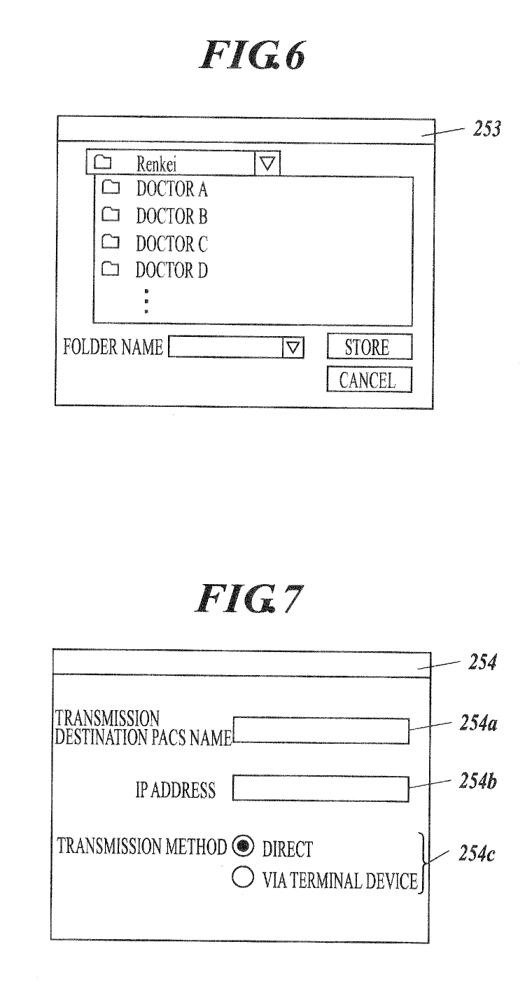

In the data download processing, first, the download destination selection screen 253 for selecting the download destination of the file of the medical information data displayed in the medical information display field 252b is displayed in the viewer screen 252. FIG. 6 shows an example of the download destination selection screen 253. The download destination which can be selected on the download destination selection screen 253 is a folder of the storage unit 23 of the terminal device 2A. When the download destination is selected from the download destination selection screen 253 with the operation unit 24, the information of the selected download destination is stored in the RAM 22 and the transmitting demand of the file of the medical information data which is the display target of the viewer screen 252 is transmitted to the center server 1 with the communication unit 26.

In the center server 1, when the transmitting demand of the file of the medical information data which is the display target of the viewer screen 252 is received from the terminal device 2A with the communication unit 16, the file of the medical information data demanded from the storage unit 13 is read out. Then, the file of the read out medical information data is transmitted to the terminal device 2A with the communication unit 16.

In the terminal device 2A, when the medical information data file is received with the communication unit 26, the file of the received medical information data is stored in the download destination stored in the RAM 22.

As described above, a data storing button 252f for downloading data displayed in the medical information display field 252b to the terminal device 2A is provided in the viewer screen 252. When the data storing button 252f is pressed, the medical information data displayed in the medical information display field 252b is downloaded from the center server 1. Therefore, the user can first view on the Web the medical information data transmitted to the user and import the data in the terminal device 2A only when the user determines that the data is necessary.

### (PACS Transmitting Processing)

When the PACS transmitting button 252g is pressed with the operation unit 24 in the viewer screen 252, the PACS transmitting processing is executed.

The PACS transmitting processing is processing which transmits medical information data displayed in the medical information display field 252b to the address of the PACS 3A in the facility registered in advance as the transmission destination PACS in the storage unit 23 of the terminal device 2A.

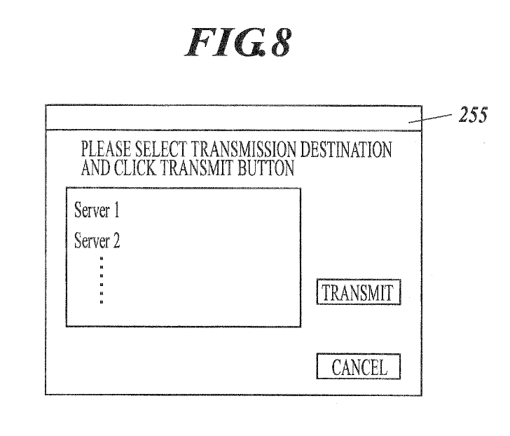

Here, the information of the PACS 3A of the transmission destination can be registered from the registration screen 254 displayed by pressing the transmission destination PACS registering button 252l with the operation unit 24. As shown in FIG. 7, other than a transmission destination PACS name input field 254a and a transmission destination PACS IP address input field 254b, the registration screen 254 is provided with a selection field 254c for selecting a transmitting method of (1) direct or (2) via the terminal device. The transmitting method of (1) direct is a method to transmit the file of the medical information data directly to the PACS 3A in the facility from the center server 1. This method can be selected when the PACS 3A is able to directly connect with the external network. The transmitting method of (2) via the terminal device is a transmitting method which transmits the file of the medical information data from the center server 1 to the terminal device 2A and then forwards the file of the medical information data received with the terminal device 2A to the IP address of the PACS 3A in the facility. When the PACS 3A is not able to directly connect with the external network, the method (2) can be selected to import the medical information data in the PACS 3A. The information of the transmission destination PACS and the method of transmitting the data input from the registration screen 254 are stored in a PACS information region of the storage unit 23.

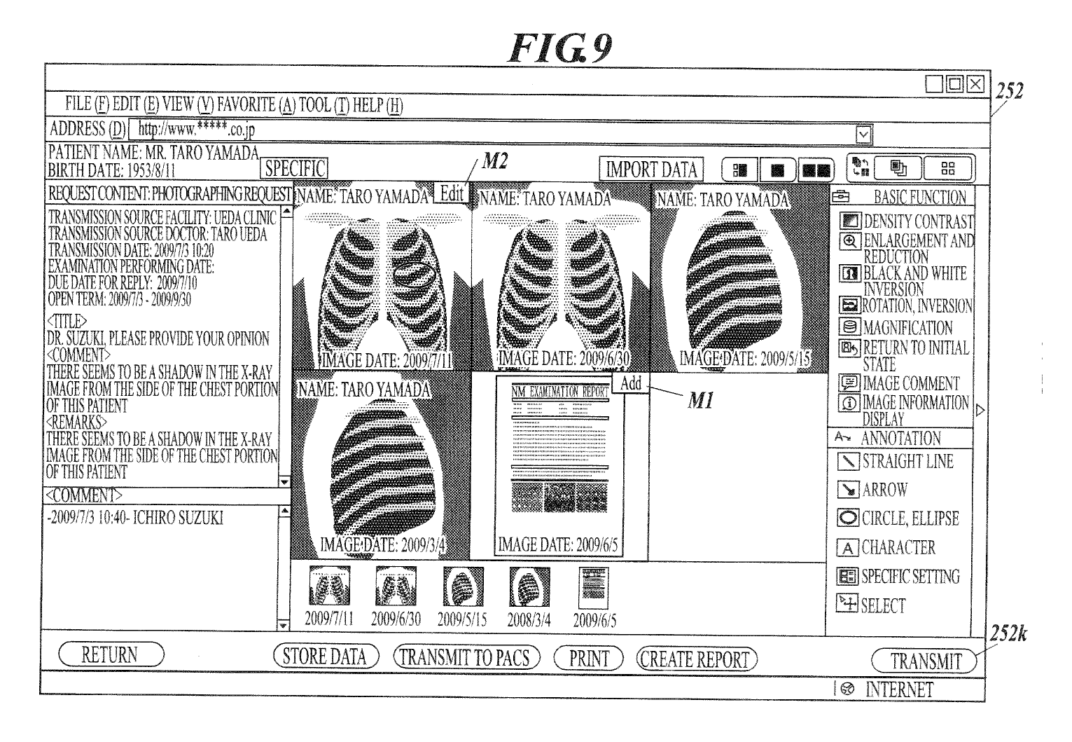

In the PACS transmitting processing, first, in the terminal device 2A, the transmission destination PACS information is read out from the PACS information region of the storage unit 23. When there are a plurality of pieces of read out transmission destination PACS information, a transmission destination PACS selection screen 255 as shown in FIG. 8 is displayed on the viewer screen 252. The transmission destination PACS selection screen 255 is a screen which displays as a list the names of the transmission destination PACS stored in the PACS information region of the storage unit 23 to allow selection. When the transmission destination PACS is selected with the operation unit 24 in the transmission destination PACS selection screen 255, the transmitting method corresponding to the selected transmission destination PACS is obtained from the PACS information region of the storage unit 23 and it is judged whether the transmitting method is “direct”.

When the transmitting method is “direct”, the IP address of the selected transmission destination PACS and the demand to transmit to the PACS 3A the file of the medical information data which is the display target of the viewer screen 252 is transmitted to the center server 1 with the communication unit 26. In the center server 1, when the demand to transmit to the PACS 3A the file of the medical information data which is the display target of the viewer screen 252 is received from the terminal device 2A with the communication unit 16, the file of the medical information data of the transmitting demand is read out from the storage unit 13. Then, the file of the read out medical information data is transmitted to the IP address of the transmission destination PACS with the communication unit 16.

When the transmission destination is “via terminal device”, a demand to transmit to the terminal device 2A the file of the medical information data which is the display target of the viewer screen 252 is transmitted to the center server 1 with the communication unit 26. In the center server 1, when the communication unit 16 receives the transmitting demand of the file of the medical information data which is the display target of the viewer screen 252 from the terminal device 2A, the file of the medical information data of the transmitting demand is read out from the storage unit 13. Then, the read out file of the medical information data is transmitted to the terminal device 2A with the communication unit 16. In the terminal device 2A, when the file of the medical information data is received with the communication unit 26, the received file is forwarded to the IP address of the transmission destination PACS.

In the PACS 3A, the received file of the medical information data is stored in the storage unit such as the HDD.

When the PACS transmitting button 252g is pressed in a state where the medical information data is selected from the medical information display field 252b with the operation unit 24, the information specifying the selected medical information data is transmitted to the center server 1 and only the selected medical information data can be transmitted to the PACS 3A.

As described above, in the viewer screen 252, when the medical information data displayed in the medical information display field 252b is imported from the center server 1 to the PACS 3A, the user can select the transmitting method between “direct” or “via terminal device”, and the center server 1 can transmit the medical information data to the PACS 3A in the selected transmitting method. Therefore, even in a medical facility which cannot directly connect the PACS 3A to the external network as the policy of the facility, the regional medical coordination system 100 can be used, and it is possible to realize online data coordination that can deal with communication conditions of various medical facilities.

### (Comment Reply Processing)

In the viewer screen 252, when a comment is input from the comment input field 252d with the operation unit 24 and the transmitting button 252k is pressed, the comment reply processing is executed.

In the comment reply processing, in the terminal device 2A, the data of the comment input from the comment input field 252d is transmitted to the center server 1 with the communication unit 26 as a reply to the transmission source of the displayed medical information data.

In the center server 1, when comment data is received from the terminal device 2A with the communication unit 16, the history information of the received comment data is created and stored in the transmitted and received history table 133. For example, history information is created so that the “transmission destination information” and the “transmission source information” in the history information of the medical information data which is the display target in the terminal device 2A stored in the RAM 12 are exchanged, the time obtained by the time keeping unit 17 is to be the transmitted date and time, the received comment data is added to the “comment” of the history information, and the “request/reply division” of the history information is to be “reply” and the history information is written in the transmitted and received history table 133 as the new record.

In addition to the reply including the comment, new medical information data can be imported from the PACS 3A and transmitted as the reply. The new medical information data includes, for example, image data and sample examination data showing a result when an additional examination is performed in the facility, interpretation report data which is created and the like. As types of medical information data, data in various file formats can be attached such as DICOM image data, general purpose still image data and moving image data (JPEG, BMP, AVI, MPEG, etc.), document data, PDF data, etc.

New medical information data can be imported by executing the following.

First, in the viewer screen 252 displayed in the terminal device 2A, when the data importing button 252h is pressed with the operation unit 24, the patient information of the patient who is the display target in the present viewer screen 252 is transmitted to the PACS 3A in the facility with the communication unit 26, and in the PACS 3A a query of the medical information data stored associated with the patient information is made in the PACS 3A. When a list of the medical information data stored associated with the patient information is received with the communication unit 26 as a response from the PACS 3A, the screen displaying the received list is displayed on the viewer screen 252. When the imported medical information data is selected from the screen of the list with the operation unit 24, the transmitting request of the selected medical information data is transmitted with the communication unit 26 to the PACS 3A and the screen of the list is closed. When the selected medical information data is received through the communication unit 26 from the PACS 3A, the received medical information data is displayed in the medical information display field 252b. The received medical information data is displayed added with a mark M1 (see FIG. 9) showing that the medical information data is newly added medical information data. When the transmitting button 252k is pressed, newly imported medical information data (when there is input of a comment from the comment input field 252d, also data of the comment) is transmitted as a reply to the transmission source of the original medical information data to the center sever 1 with the communication unit 26.

In the center server 1, when the new medical information data is received from the terminal device 2A with the communication unit 16, the new medical information data is stored in the storage unit 13. Specifically, the “file path” which is stored in the RAM 12 and which is in the history information of the medical information data which is the display target is referred and the new medical information data is stored in the same folder as the medical information data which is the display target. The history information which shows that the new medical information data is received is generated and stored in the transmitted and received history table 133. For example, history information is created so that the “transmission destination information” and the “transmission source information” in the history information of the medical information data which is the display target in the terminal device 2A stored in the RAM 12 are exchanged, the time obtained by the time keeping unit 17 is to be the transmitted date and time, the received comment data is added to the “comment” of the history information, the “request/reply division” of the history information is to be “reply”, and the file path of the received medical information data is added to the “file path”. The history information is written in the transmitted and received history table 133 as the new record.

The history information of the comment and new medical information data as the reply from the terminal device 2A is displayed in the history information field 251c when the doctor of the transmission source of the original medical information data logs in to the coordinate service from the terminal device of the medical facility, such as the terminal device 2B and displays his coordination transmitted and received history screen 251. Therefore, the doctor of the transmission source can easily confirm that the comment and the new medical information data are received as a reply. In the coordination transmitted and received history screen 251, when the doctor of the transmission source selects the history information corresponding to the reply displayed in the history information field 251c with the operation unit 24, the above described medical information display processing is executed and the viewer screen 252 including the comment and the new medical information data received as the reply is displayed. Therefore, the doctor of the transmission source can confirm the medical information data and the content of the comment received as the reply.

As described above, in the viewer screen 252, the user can transmit a comment as a reply to the transmission source of the medical information data and provide new medical information data which is coordinated with the request source such as examination result, etc. performed in the facility.

### (Medical Information Data Editing Processing)

In the viewer screen 252, the medical information data (here, medical image data) of the editing target is selected from the medical information display field 252b with the operation unit 24. Then, when any of the editing buttons 252e is operated, editing processing corresponding to the pressed editing button 252e is executed on the selected medical information data. Then, the edited medical information data is displayed additionally in the medical information display field 252b. The edited medical information data is displayed added with a mark M2 (see FIG. 9) showing that the medical information data is edited medical information data. When the transmitting button 252k is pressed with the operation unit 24, edited medical information data (when there is input of a comment from the comment input field 252d, also data of the comment) is transmitted as a reply to the center sever 1 with the communication unit 26. The edited medical information data has a file name such as a file name with an identification number showing that the data is edited attached to the file name of the medical information data before editing so that it is possible to identify in the center server 1 which medical information data is an edited file.

In the center server 1, when the coordination information including the edited medical information data is received with the communication unit 16, the edited medical information data is stored in the storage unit 13. Specifically, the “file path” which is stored in the RAM 12 and which is in the history information of the medical information data which is the display target is referred and the edited medical information data is stored in the same folder as the medical information data which is the display target. The history information which shows that the edited medical information data is received is generated and stored in the transmitted and received history table 133. For example, history information is created so that the “transmission destination information” and the “transmission source information” in the history information of the medical information data which is the display target in the terminal device 2A stored in the RAM 12 are exchanged, the time obtained by the time keeping unit 17 is to be the transmitted date and time, the received comment data is added to the “comment” of the history information, the “request/reply division” of the history information is to be “reply”, and the file path of the received medical information data is added to the “file path”. The history information is written in the transmitted and received history table 133 as the new record.

The edited medical information data can be displayed on the viewer screen 252 when the user of the transmission source of the medical information data before editing logs in to the coordination service from the terminal device (here, described as terminal device 2B) of the medical facility and selects the history information from the history information field 251c of the coordination transmitted and received history screen 251 to execute the medical information display processing.

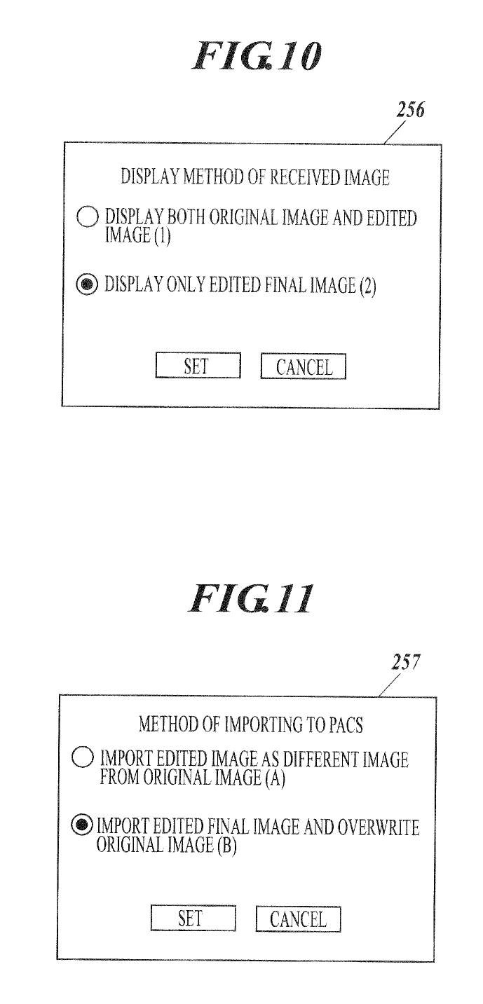

As the method of displaying the edited medical information data (image) in the viewer screen 252, the user can select between (1) display both the original image and the edited image and (2) display only the final edited image. Specifically, when the display setting button 251h displayed in the coordination transmitted and received history screen 251 is pressed with the operation unit 24, a display setting screen 256 shown in FIG. 10 is displayed. When either displaying method of (1) or (2) is selected from the display setting screen 256, the information showing the selected displaying method is stored in a displaying method setting region of the storage unit 23. When the history information of the edited medical information data is selected with the operation unit 24 in the coordination transmitted and received history screen 251, the information specifying the selected history information (for example, request ID, transmitting date and time, etc.), in addition to the display demand of the medical information data corresponding to the history information, the information of the displaying method stored in the displaying method setting region of the storage unit 23 is transmitted to the center server 1 with the communication unit 26. In the center server 1, the display data displayed in the viewer screen 252 is generated based on the received displaying method and transmitted to the terminal device 2B with the communication unit 16.

In the terminal device 2B, the viewer screen 252 is displayed based on the generated display data. For example, when (1) display of both the original image and the edited image is selected as the displaying method, the original image and the edited image are displayed aligned in the viewer screen 252 and the edited image is displayed added with a mark M2 (see FIG. 9) showing that the image is edited. When (2) display only the edited final image is selected as the displaying method, only the edited final image is displayed in the viewer screen 252.

When the edited medical information data is imported (stored) in the PACS 3B, the user can select the importing method between (1) import the edited image as a separate image from the original image (separate storing) or (2) import the edited final image and overwrite the original image (overwrite storing).

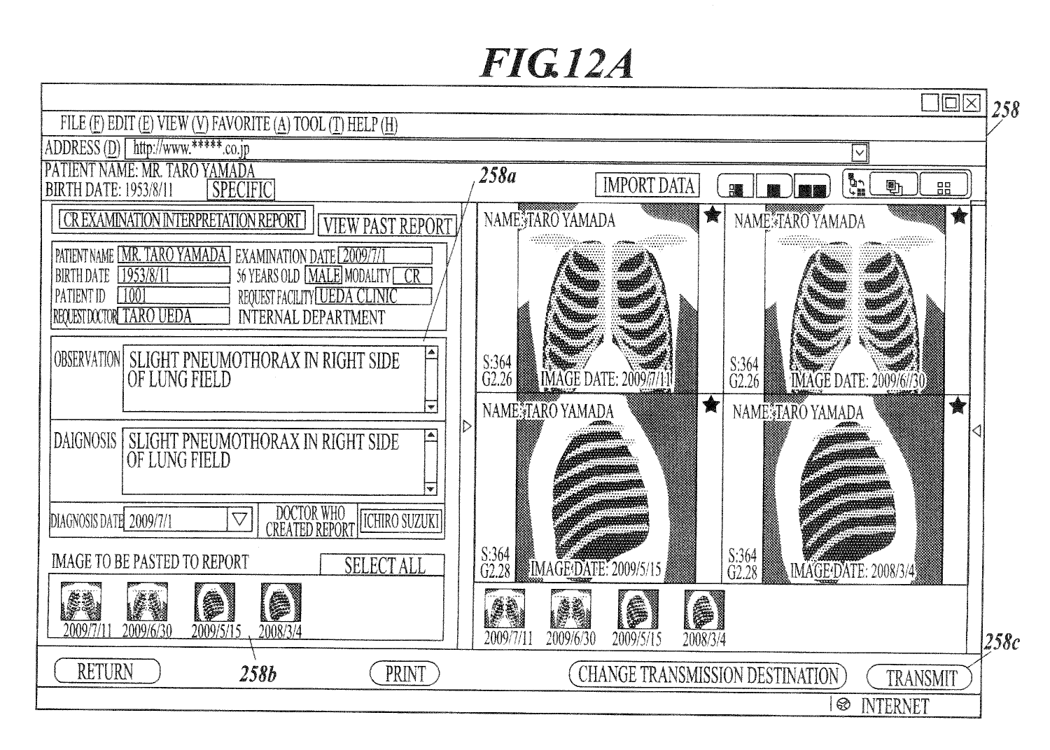

Specifically, when the edited medical information data is included in the viewer screen 252, a PACS import setting button (tenth functional button, not shown) for selecting the importing method of the medical information data (image) in the PACS 3B is displayed in the viewer screen 252. When the PACS import setting button displayed in the viewer screen 252 is pressed with the operation unit 24, a PACS import setting screen 257 is displayed. As shown in FIG. 11, the PACS import setting screen 257 is a selection screen for selecting the importing method of (1) or (2) as the importing method of the medical information data (image) in the PACS 3. When the importing method of either (1) or (2) is selected from the PACS import setting screen 257 with the operation unit 24, the information showing the selected importing method is stored in a PACS importing method setting region of the storage unit 23.

When the edited medical information data is selected with the operation unit 24 and then the PACS transmitting button 252g is pressed, the above described PACS transmitting processing is executed, and when it is judged that the transmitting method is “direct”, in addition to the IP address of the transmission destination PACS and the transmitting demand of the edited medical information data to the PACS 3B, the information showing the importing method (separate storing or overwrite storing) stored in the PACS importing method setting region of the storage unit 23 is transmitted to the center server 1 with the communication unit 26.

In the center server 1, when the importing method is separate storing, among the medical information data displayed in the viewer screen 252, the file of the edited medical information data is read out from the storage unit 13 and transmitted to the specified IP address with the communication unit 16. When the importing method is overwrite, the file of the edited medical information data is read out from the storage unit 13, the file name is changed to the file name of the medical information data before editing and the file is transmitted to the specified IP address.

In the PACS 3B, when the file of the medical information data is received from the center server 1, the received medical information data is stored in the storage unit such as the HDD, etc. When there is a file with the same file name, the PACS 3B overwrites and stores the file.

Alternatively, when it is judged that the transmitting method is “via terminal device” in the PACS transmitting processing, in addition to the transmitting demand of the edited medical information data to the terminal device 2B, information showing the importing method (separate storing or overwrite storing) stored in the PACS importing method setting region of the storage unit 23 is transmitted to the center server 1 with the communication unit 26.

In the center server 1, when the PACS importing method is separate storing, among the medical information data displayed in the viewer screen 252, the file of the edited medical information data is read out from the storage unit 13 and transmitted to the terminal device 2B with the communication unit 16. When the storing method is overwrite, the edited medical information data is read out from the storage unit 13, the file name is changed to the file name of the medical information data before editing and the file is transmitted to the terminal device 2B.

In the terminal device 2B, the edited medical information data transmitted from the center server 1 is transmitted to the PACS 3B with the communication unit 26.

In the PACS 3B, when the file of the edited medical information data is received from the terminal device 2B, the received medical information data is stored in the storage unit such as the HDD, etc. When there is a file with the same file name, the PACS 3B overwrites and stores the file.

As described above, with the viewer screen 252, the user can edit the medical information data displayed in the medical information display field 252b to be easily viewed, and the edited medical information data can be provided to the doctor of the transmission source.

When the doctor of the transmission source of the medical information data before editing imports the edited medical information data in the PACS 3B of the facility, the doctor can select whether to store the medical information data before and after editing as separate files or to overwrite the file of the medical information data before editing with the edited medical information data with the button operation on the viewer screen 252. Therefore, it is possible to easily store the file of the medical information data according to the policy of the facility.

When the doctor of the transmission source of the medical information data before editing displays the edited medical information data in the viewer screen 252, the edited medical information data can be displayed aligned with the medical information data before editing or only the final medical information data can be displayed according to the selection by the doctor. Therefore, the edited medical information data can be displayed in a method to be easily viewed by the doctor of the transmission source. The edited medical information data is displayed added with a mark M2 showing that the data is edited. Therefore, the user can easily understand which data is edited data.

### (Report Creating Processing)

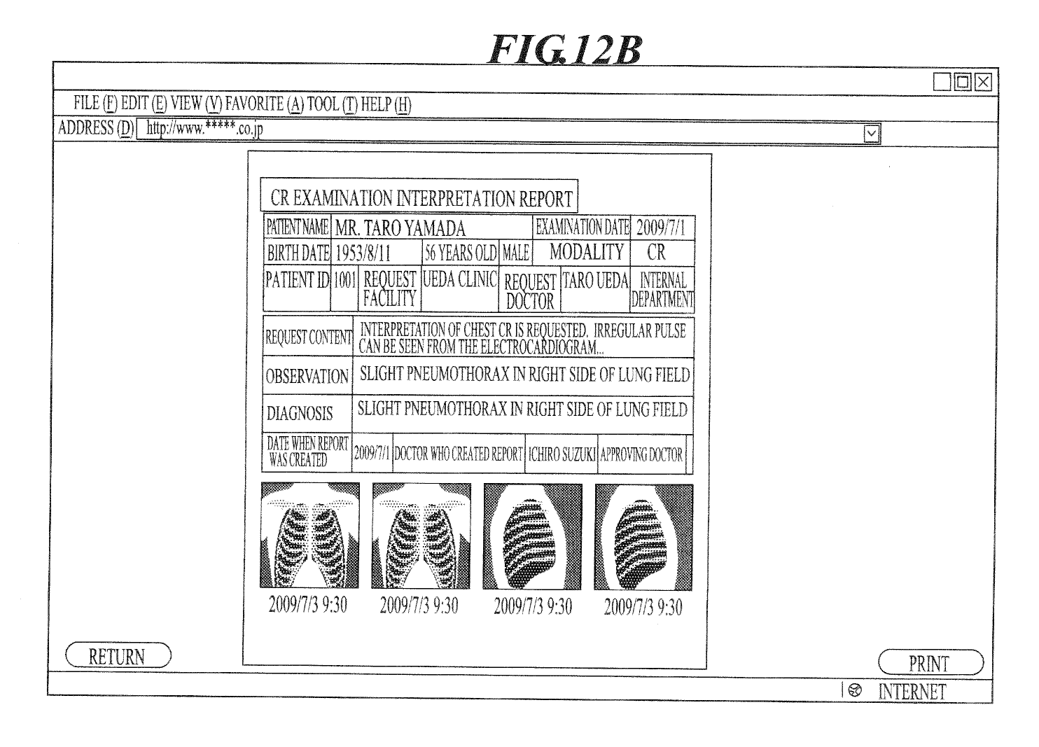

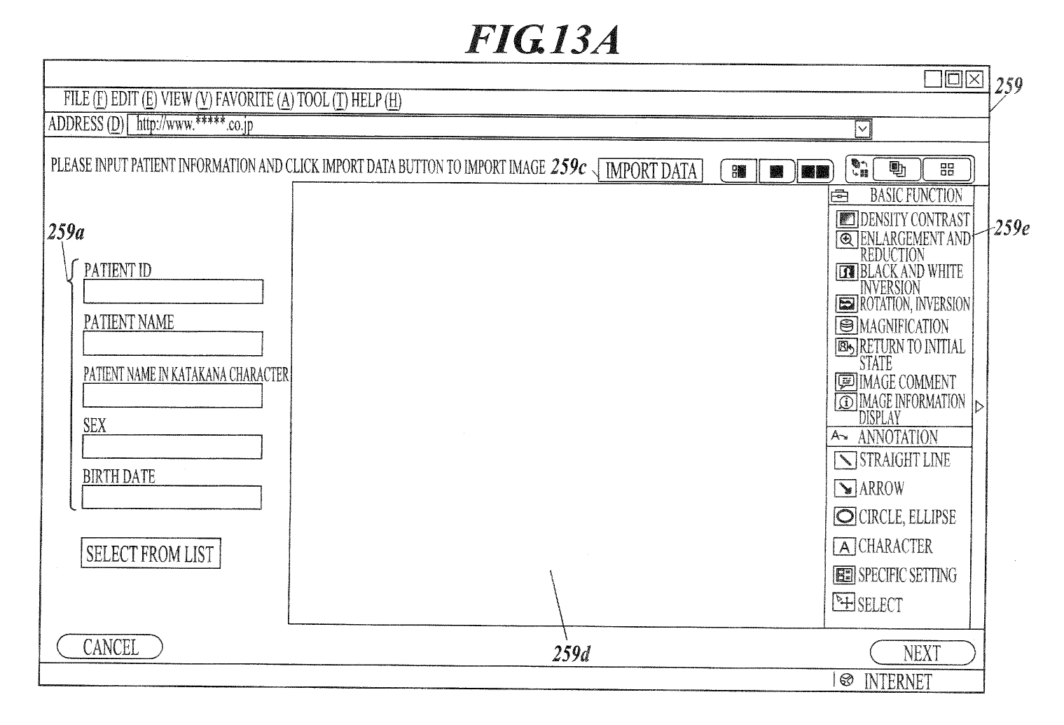

When a report creating button 252j is pressed with the operation unit 24 in the viewer screen 252, a report creating screen 258 is displayed. As shown in FIG. 12A, the report creating screen 258 is provided with an input field 258a to input observation, diagnosis, date and time, doctor name of the medical information data, selection field 258b of the medical information data added to the interpretation report, and the like. When the input of the content of the interpretation report is performed from the input field 258a of the report creating screen 258 with the operation unit 24 and the transmitting button 258c is pressed, the interpretation report is created according to the predetermined format as shown in FIG. 12B and is transmitted as the reply to the transmission source of the medical information data displayed in the viewer screen 252 to the center server 1 with the communication unit 26.

In the center server 1, when the interpretation report is received with the communication unit 16, the received interpretation report is stored in the storage unit 13. Specifically, the “file path” in the history information of the medical information data which is the display target stored in the RAM 12 is referred and the interpretation report is stored in the same folder as where the medical information data is stored. The history information of receiving the received interpretation report is generated and stored in the transmitted and received history table 133. For example, history information is created so that the “transmission destination information” and the “transmission source information” in the history information of the medical information data which is the display target in the terminal device 2A stored in the RAM 12 are exchanged, the time obtained by the time keeping unit 17 is to be the transmitted date and time, the received comment data is added to the “comment” of the history information, the “request/reply division” of the history information is to be “reply”, and the file path of the received medical information data is added to the “file path”. The history information is written in the transmitted and received history table 133 as the new record.

When the doctor of the transmission source of the medical information data logs in to the coordination service from the terminal device of the facility, for example terminal device 2B, the doctor selects the history information regarding receiving the interpretation report from the history information field 251c of the coordination transmitted and received history screen 251 to execute the medical information display processing, and the interpretation report is displayed in the medical information display field 252b of the viewer screen 252 together with the medical information data which is the target of interpretation.

As described above, with the viewer screen 252, the user can create an interpretation report and provide the report to the request source.

### (Print Processing)

When the medical information data of the print target is selected from the medical information display field 252b with the operation unit 24 in the viewer screen 252 and the printing button 252i is pressed, the print data of the selected medical information data is generated and the print data is output by printing on a sheet with the print unit 28.

As described above, with the viewer screen 252, the user can easily print the displayed medical information data.

In the above description, the processing of the user confirming the medical information data for the user, in other words, the medical information data which the user is allowed to view stored in the center server 1 and various processing which can be executed on the confirmed medical information data is described. Below, the processing of the user transmitting a new coordination request is described. The terminal device 2A performing the processing of the terminal device is described as a representative example, however, similar processing is performed in the terminal device 2B.

### (New Coordination Request Transmitting Processing)

In the coordination transmitted and received history screen 251 shown in FIG. 4, when the “new transmission” button 251f is pressed with the operation unit 24, new coordination request transmitting processing is executed.

In the new coordination request transmitting processing, a display demand of a medical information importing screen 259 for importing from the PACS 3A medical information data which is to be transmitted to the affiliate is transmitted to the center server 1 with the communication unit 26. In the center sever 1, when the display demand of the medical information importing screen 259 is received, the display data of the medical information importing screen 259 is read out from the storage unit 13 and transmitted to the terminal device 2A with the communication unit 16. In the terminal device 2A, when the display data is received from the center server 1, the medical information importing screen 259 is displayed on the display unit 25 based on the received display data.

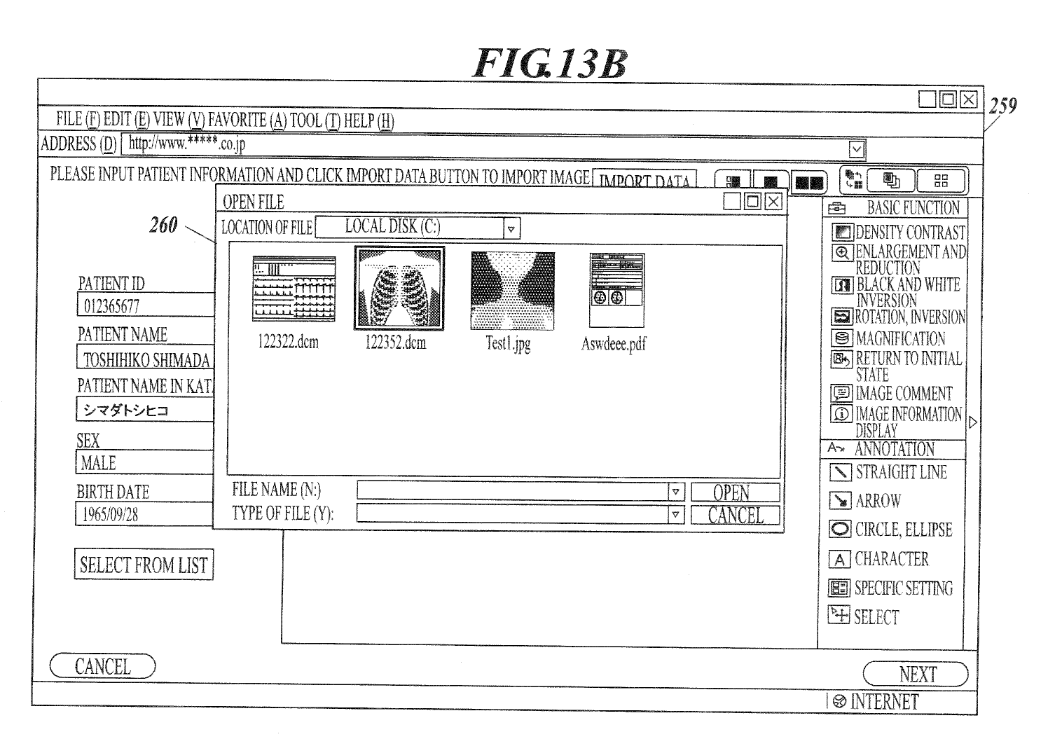

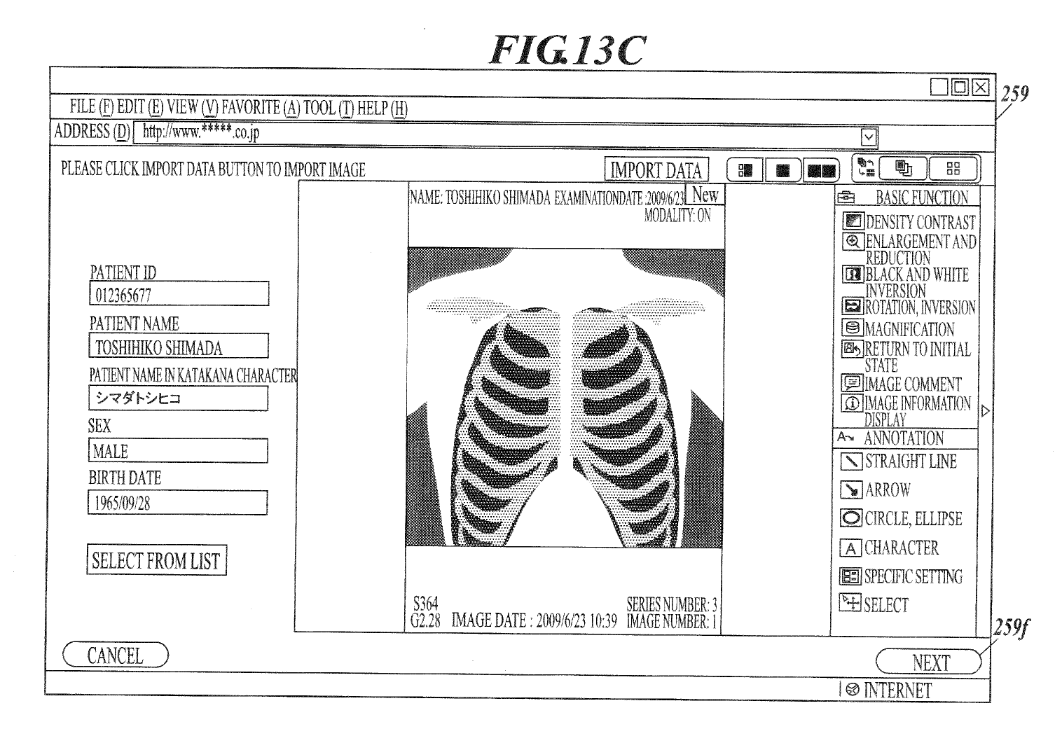

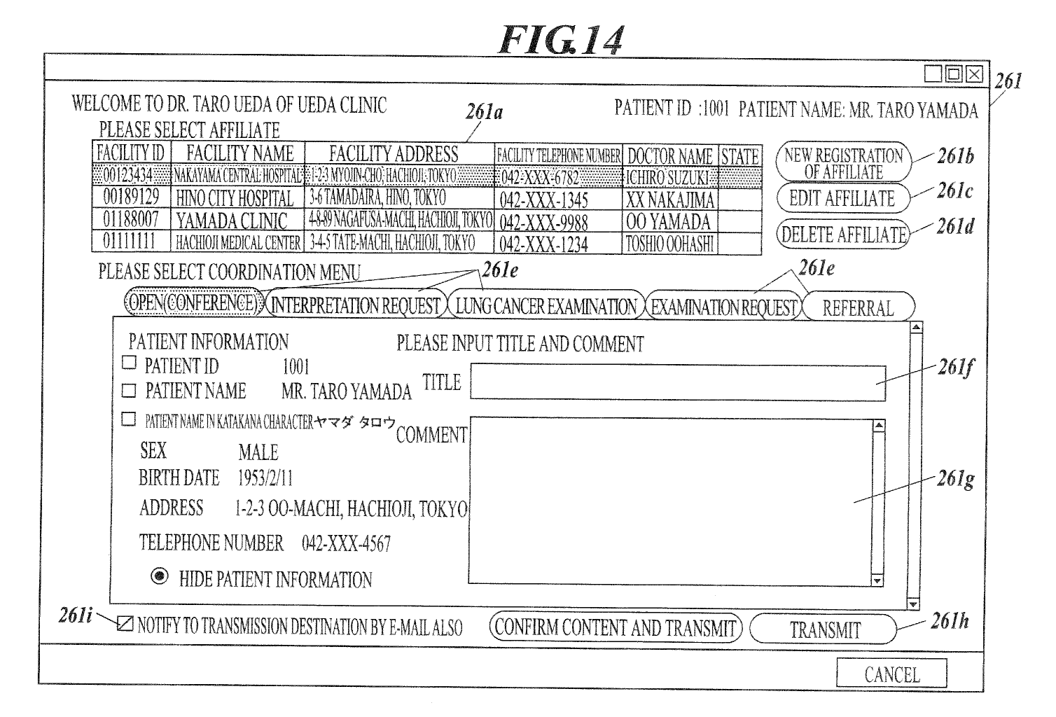

FIG. 13A shows an example of the medical information importing screen 259. As shown in FIG. 13A, the medical information importing screen 259 is provided with a patient information input field 259a, a data importing button 259c, a medical information display field 259d, and various editing function buttons 259e.

The patient information input field 259a is a region for inputting patient information of a patient who is the target of the coordination request.

The data importing button 259c is a functional button (twelfth functional button) for importing from the PACS 3A of the facility medical information data of a patient whose patient information is input in the patient information input field 259a.

The medical information display field 259d is a field for displaying medical information data imported from the PACS 3A.

The various editing function buttons 259e are buttons for performing various editing on the medical image when the medical information data displayed in the medical information display field 259d is medical image data.

When the patient information is input from the patient information input field 259a and the data importing button 259c is pressed with the operation unit 24, a retrieving demand of medical information data including patient information which matches with the input patient information is transmitted to the PACS 3A of the facility with the communication unit 26. When the retrieved result is received from the PACS 3A with the communication unit 26, a medical information selection screen 260 displaying the received retrieved result, in other words, a list of the retrieved medical information data (thumbnail image of the medical information data, file name, etc.) is displayed in the medical information importing screen 259. FIG. 13B shows an example of the medical information selection screen 260. When the medical information data of the importing target is selected with the operation unit 24 from the medical information selection screen 260, the medical information selection screen 260 is closed and the transmitting demand of the selected medical information data is transmitted to the PACS 3A with the communication unit 26. When the file of the medical information data is received from the PACS 3A with the communication unit 26, the received medical information data is displayed in the medical information display field 259d as shown in FIG. 13C. A next button 259f instructing moving to the next screen is displayed in the medical information importing screen 259.

In the medical information importing screen 259, when the next button 259f is pressed with the operation unit 24, the received medical information data and the input patient information is stored in the RAM 22 and the moving demand to the next screen is transmitted to the center server 1 with the communication unit 26.

In the center server 1, when the moving demand to the next screen is received with the communication unit 16, the record including the user ID which matches with the user ID of the login user, in other words, the affiliate information registered by the login user is retrieved from the affiliate table 132. Then, display data of an affiliate selection screen 261 as a request input screen for the terminal device 2A to input selection of affiliate permitted to view the medical information data imported from the PACS 3A and to input the request content is generated based on the retrieved affiliate information and the display data is transmitted to the terminal device 2A with the communication unit 16.

In the terminal device 2A, when the display data is received with the communication unit 26, the affiliate selection screen 261 is displayed on the display unit 25.

FIG. 14 shows an example of an affiliate selection screen 261. As shown in FIG. 14, the affiliate selection screen 261 is provided with an affiliate selection field 261a, an affiliate new registration button 261b, an affiliate editing button 261c, an affiliate delete button 261d, a coordination menu selection field 261e, a title input field 261f, a comment input field 261g, a transmitting button 261h and the like.

The affiliate selection field 261a is a region for displaying the affiliate information which the login user registered in advance as the affiliate candidate as a list and selecting the transmission destination of the coordination request this time, in other words, the affiliate allowed to view the imported medical information data from the affiliate candidate displayed in a list.

The affiliate new registration button 261b is a button for inputting an instruction to newly register an affiliate which is not displayed in the affiliate selection field 261a. When the affiliate new registration button 261b is pressed, the input field of the affiliate is displayed, and the affiliate information input from the input field is transmitted to the center server 1 to be registered in the affiliate table 132.

The affiliate editing button 261c is a button for input of an instruction to edit the affiliate displayed in the affiliate selection field 261a. When the affiliate editing button 261c is pressed, the editing screen of the affiliate information in a selected state at present in the affiliate selection field 261a is displayed, the affiliate information input from the editing screen is transmitted to the center server 1 and the corresponding information of the affiliate table 132 is rewritten to the edited affiliate information.

The affiliate delete button 261d is a button for inputting instruction of deleting an affiliate displayed in the affiliate selection field 261a. When the affiliate delete button 261d is pressed, a message to execute deleting of the affiliate information in a selected state at present in the affiliate selection field 261a and an OK button are displayed. When the OK button is pressed, the demand to delete the affiliate information is transmitted to the center server 1 with the communication unit 26. In the center server 1, the affiliate information of the delete demand is deleted from the affiliate table 132.

The coordination menu selection field 261e is a region for input of selection of content of the request to the affiliate. Here, selection of the request content can be made from open (conference), interpretation request, lung cancer examination, examination request, referral, etc.

The title input field 261f is a field for input of the title of the coordination request. The comment input field 261g is a field for input of the comment of the coordination request.

The transmitting button 261h is a functional button (thirteenth functional button) for transmitting to the center server 1 the affiliate selected in the affiliate selection screen 261, the request content selected from the coordination menu selection field 261e, and the imported medical information data as the coordination request.

When the input items are input from the affiliate selection field 261a, the coordination menu selection field 261e, the title input field 261f and the comment input field 261g and the transmitting button 261h is pressed with the operation unit 24, information specifying the selected affiliate (affiliate facility ID and affiliate doctor ID, etc.), information showing the selected request content, input title and comment, medical information data imported from the PACS 3A and stored in the RAM 22, and patient information are transmitted as a new coordination request from the terminal device 2A to the center server 1 with the communication unit 26.

In the center server 1, when the medical information data, etc. of the coordination request is received with the communication unit 16, the received medical information data is stored in the folder of the login user. The history information of the received medical information data is created and stored in the transmitted and received history table 133. For example, history information is created so that the “facility ID”, the “facility name”, the “user ID” and the “doctor name” of the user information of the login user are to be the “transmission source facility ID”, the “transmission source facility name”, the “transmission source doctor ID”, and the “transmission source doctor name”, and the “affiliate facility ID”, the “affiliate facility name”, the “affiliate doctor ID”, and the “affiliate doctor name” of the affiliate information in the affiliate table 132 and specified by the information specifying the selected affiliate are to be the “transmission destination facility ID”, the “transmission destination facility name”, the “transmission destination doctor ID”, and the “transmission destination doctor name”, the time obtained by the time keeping unit 17 is to be the “transmitted date and time”, the received comment is to be the “comment”, the received title is to be the “title”, the “request/reply division” is to be “request” and the file path of the received medical information data is to be the “file path”. The history information is written in the transmitted and received history table 133 as the new record.

In the terminal device 2A, when a check is added with the operation unit 24 to a check box 261i showing “notify to transmission destination by e-mail also” in the affiliate selection screen 261, e-mail notification demand is transmitted to the affiliate when new medical information data is transmitted from the terminal device 2A to the center server 1. In the center server 1, when the e-mail notification demand is received, the e-mail address of the affiliate is obtained from the affiliate table 132 and e-mail which notifies the receiving of the affiliate request is transmitted to the e-mail address.

According to the new coordination request transmitting processing, a new coordination request can be transmitted from the terminal device 2A. Selection of the request content can be made from open (conference), interpretation request, lung cancer examination, examination request, referral, etc. Similar processing can be performed in the terminal device 2B to transmit the coordination request.

### (Modification)

In the PACS 3A and 3B, in the display program of the viewer screen for displaying on the display unit the medical information data of the medical image, etc. stored in the storage unit of the device and executed by the control unit, the following functions of (1) to (5) can be included so that the medical information data displayed in the viewer screen of the PACS 3A and 3B can be directly transmitted to the center server 1 and the coordination can be requested without newly starting the Web browser 231 in the terminal devices 2A and 2B.

For example, the following functions are included (1) a function to display a coordination icon for instruction of a coordination request on the viewer screen, (2) a function to display a selection screen for selecting medical information data which is to be the target of the coordination request from the medical information data displayed in the viewer screen when the coordination icon is pressed with the operation unit and to store in the RAM the selected medical information data and the patient information of the patient which is the target of display in the viewer screen when the medical information data of the coordination target is selected from the selection screen, (3) a function to store in advance a user ID and a password for using the coordination service of the center server 1 in a storage unit, (4) a function to start a built-in browser for coordination to access to the center server 1 when the medical information data is selected, and to automatically transmit the user ID and the password stored in the storage unit to the center server 1, (5) a function to access to the URL of the affiliate selection screen 261 of the center server 1 after authorization by the center server 1 and to obtain the display data of the affiliate selection screen 261 to display the display data on the display unit.

The affiliate selection screen 261 includes a function to input the affiliate and the request content and to transmit the information with the medical information data imported in the RAM to the center server 1 with the communication unit. Therefore, by including the functions of (1) to (5) in the display program of the viewer screen of the PACS 3A and 3B, the medical information data can be easily transmitted (uploaded) to the center server 1 from the PACS 3A and 3B without using the terminal device.

The regional medical coordination system 100 of the present invention is described above. However, the description of the above embodiments is a suitable example of the present invention, and the present invention is not limited to the above.

For example, the above description discloses an example of using an HDD, a nonvolatile semiconductor memory or the like as the computer readable medium including the program of the present invention, however the invention is not limited to the above. As other computer readable mediums, a portable recording medium such as a CD-ROM can be applied. Moreover, as a medium to provide program data of the present invention through communication lines, a carrier wave can be applied.

The detailed configuration and the detailed operation of each device composing the regional medical coordination system 100 can be suitably modified without leaving the scope of the invention.

The entire disclosure of Japanese Patent Application No. 2010-031277 filed on Feb. 16, 2010 to the Japanese Patent Office including specification, claims, drawings and abstract are incorporated herein in the present U.S. patent application.

### INDUSTRIAL APPLICABILITY

The present invention can be applied to data coordination among medical facilities in the field of medicine.

### DESCRIPTION OF REFERENCE NUMERALS

100 regional medical coordination system
1 center server
11 control unit
12 RAM
13 storage unit
P1 Web server program
P2 viewer program
131 user management table
132 affiliate table
133 transmitted and received history table
14 operation unit
15 display unit
16 communication unit
17 time keeping unit
18 bus
2A, 2B terminal device
21 control unit
22 RAM
23 storage unit
231 Web browser
24 operation unit
25 display unit
251 coordination transmitted and received history screen
252 viewer screen
253 download destination selection screen
254 registration screen
255 transmission destination PACS selection screen
256 display setting screen
257 PACS import setting screen
258 report creating screen
259 medical information importing screen
260 medical information selection screen
261 affiliate selection screen
26 communication unit
27 time keeping unit
28 print unit
29 bus
3A, 3B PACS
4A, 4B router
5A, 5B in-facility network
6A, 6B in-facility system
N internet

1. A medical coordination system comprising:
a data management server; and
an in-facility system provided in each of a plurality of medical facilities, the in-facility system connected to the data management server through a communication network to enable transmission and reception of data,
wherein the in-facility systems each include a terminal device and an in-facility server which is connected to the terminal device and which stores medical information data generated in the medical facility, and
wherein the data management server includes a storage unit which stores medical information data transmitted from the terminal device of the in-facility system associated with identification information of a transmission source of the medical information data and identification information of an affiliate that is permitted to view the medical information data, and when transmitting the medical information data to an in-facility server of the affiliate that is permitted to view the medical information data, the transmission is performed either directly to the in-facility server of the affiliate or via the terminal device of the affiliate, in accordance with a demand from the terminal device of the affiliate.

2. he medical coordination system of claim 1, wherein:
the data management server creates a medical information display screen which displays medical information data permitted to be viewed in accordance with a demand from the terminal device of the affiliate that is permitted to view the medical information data, the medical information display screen including a first functional button to transmit to the data management server a demand to transmit the medical information data to the in-facility server of the affiliate and a second functional button to select a transmission method of the medical information data to the in-facility server from between a method of direct transmission or a method of transmission via terminal device, and the data management server transmits the medical information display screen to the terminal device of the affiliate; and
the terminal device of the affiliate displays the medical information display screen transmitted from the data management server on a display unit, and when the first functional button is pressed, the terminal device commands the data management server to transmit the displayed medical information data to the in-facility server of the affiliate with the transmission method selected using the second functional button.

3. The medical coordination system of claim 2, wherein:
the medical information display screen includes a third functional button to download medical information data displayed in the medical information display screen to the terminal device of the affiliate; and
when the third functional button of the medical information display screen is pressed, the terminal device of the affiliate demands transmission of the medical information data to the data management server and downloads the medical information data.

4. The medical coordination system of claim 2, wherein:
the medical information display screen includes an input field to input a comment on the medical information data displayed in the medical information display screen, and a fourth functional button to transmit the input comment to the data management server;
when the comment is input from the input field of the medical information display screen and the fourth functional button is pressed, the terminal device of the affiliate transmits the input comment to the data management server; and
the data management server stores in the storage unit the comment transmitted from the terminal device of the affiliate associated with identification information of the transmission source of the medical information data and the identification information of the affiliate, and transmits the comment from the affiliate to the terminal device of the transmission source in accordance with a demand from the terminal device of the transmission source of the medical information data.

5. The medical coordination system of claim 2, wherein:
the treatment information display screen includes a fifth functional button to import new medical information data from the in-facility server connected to the terminal device of the affiliate and a sixth functional button to transmit the imported medical information data to the data management server;
when the fifth functional button is pressed, the terminal device of the affiliate imports new medical information data from the in-facility server and when the sixth functional button is pressed, the imported new medical information data is transmitted to the data management server; and
the data management server stores in the storage unit the new medical information data transmitted from the terminal device of the affiliate associated with identification information of the transmission source of the original medical information data and the identification information of the affiliate, and creates the medical information display screen to display the new medical information data and transmits the medical information display screen to the terminal device of the transmission source in accordance with a demand from the terminal device of the transmission source of the original medical information data.

6. The medical coordination system of claim 2, wherein:
the medical information display screen includes a seventh functional button to create an interpretation report of the medical information data displayed in the medical information display screen;
when the seventh functional button is pressed, the terminal device of the affiliate displays an input screen to input the interpretation report and transmits the interpretation report input from the input screen to the data management server; and
the data management server stores in the storage unit the interpretation report transmitted from the terminal device of the affiliate associated with identification information of the transmission source of the medical information data and the identification information of the affiliate, and creates the medical information display screen to display the interpretation report from the affiliate together with the medical information data and transmits the medical information display screen to the terminal device of the medical facility of the transmission source in accordance with a demand from the terminal device of the transmission source of the medical information data.

7. The medical coordination system of claim 2, wherein:
the medical information display screen includes an eighth functional button to edit the displayed medical information data and a ninth functional button to transmit the edited medical information data to the data management server;
when the eight functional button is pressed, the terminal device of the affiliate performs editing processing on the displayed medical information data and when the ninth functional button is pressed, the terminal device of the affiliate transmits the edited medical information data to the data management server; and
the data management server stores in the storage unit the edited medical information data transmitted from the terminal device of the affiliate as a file different from the medical information data before editing associated with identification information of the transmission source of the medical information data before editing and the identification information of the affiliate, and creates the medical information display screen to display the edited medical information data and transmits the medical information display screen to the terminal device of the transmission source in accordance with a demand from the terminal device of the transmission source of the medical information data before editing.

8. The medical coordination system of claim 7, wherein the edited medical information data and the medical information data before editing are displayed aligned in the medical information display screen to display the edited medical information data and a mark is added to the edited medical information data to show that the medical information data is edited.

9. The medical coordination system of claim 7, wherein the medical information display screen to display the edited medical information data includes a tenth functional button to store the medical information data before editing and after editing as separate data or to overwrite the medical information data before editing with the edited medical information data in the in-facility server connected to the terminal device of the transmission source of the medical information data before editing.

10. The medical coordination system of claim 2, wherein:
each of the terminal devices includes a print device;
the medical information display screen includes an eleventh functional button to print the medical information data displayed in the medical information display screen onto a sheet; and
when the eleventh functional button is pressed, the terminal device of the affiliate allows the print device to print based on the medical information data.

11. The medical coordination system of claim 1, wherein the medical information data includes DICOM data, general use image data and a document file.

12. The medical coordination system of claim 1, wherein:
the data management server creates a medical information importing screen including a twelfth functional button to import the medical information data from the in-facility server and transmits the medical information importing screen to the terminal device in accordance with a demand from the terminal device;
the terminal device displays the medical information importing screen transmitted from the data management server on the display unit and when the twelfth functional button is pressed, the terminal device imports the medical information data from the in-facility server;
the data management server creates a request input screen including an input field to input an affiliate that is permitted to view the medical information data imported from the in-facility server and a content of request to the affiliate and a thirteenth functional button to transmit to the data management server the medical information data imported from the in-facility server and transmits the request input screen to the terminal device in accordance with a demand from the terminal device;
the terminal device displays the request input screen transmitted from the data management server on the display unit, and when the affiliate and the request content are input from the input field and the thirteenth functional button is pressed, the imported medical information data and the affiliate and the request content input from the input field are transmitted to the data management server; and
the data management server stores in the storage unit the transmitted medical information data and the request content associated with identification information of the transmission source and the identification information of the affiliate that is permitted to view the medical information data, and generates the medical information display screen to display the medical information data permitted to be viewed together with the request content and transmits the medical information display screen to the terminal device of the affiliate, in accordance with a demand from the terminal device of the medical facility of the affiliate permitted to view the medical information data.

13. The medical coordination system of claim 1,
wherein the in-facility server includes:
a storage unit which stores medical information data generated in a medical facility;
a display unit which displays the medical information data stored in the storage unit;
an operation unit which receives input of information of an affiliate that is permitted to view the medical information data displayed on the display unit; and
a transmission unit which transmits information of the affiliate input with the operation unit and the medical information data displayed on the display unit to the data management server.
